(19) United States
(12) Patent Application Publication
(10) Pub. No.: US 2006/0007684 A1
(43) Pub. Date: Jan. 12, 2006

(54) Visually enhanced switch for electronic devices

(76) Inventor: Chi-Hsiang Wang, (US)

Correspondence Address: LAW OFFICE OF KARRY W. WANG, 3342 PARK RIDGE DR, RICHMOND, CA, 94806, US

(21) Appl. No.: 10/885,386

(22) Filed: Jul. 7, 2004

(51) Int. Cl. F21V 23/04

(52) U.S. Cl. 362/276

(57) ABSTRACT

A control feature for an electronic device is disclosed, comprising a means for displaying a light sequence or pattern when a function of the electronic device is activated or deactivated. Preferably, the light sequence or pattern is displayed using LED lights, each of which is also used to indicate the activation, status, or degree of a particular function of the electronic device.

### FIELD OF THE INVENTION

The present invention relates generally to an electronic device switch, and more particularly to an electronic switch capable of producing a visual effect display.

### BACKGROUND OF THE INVENTION

It is well known that certain personal, home and sometimes commercial electronics sell better or at a higher price than others not because their functional capabilities are superior, but because their physical designs are more aesthetically appealing to the consumers.

Often times, consumers favor certain electronic devices because they are designed to convey a “high-tech” style or appearance. For example, Motorola, Inc. has acquired much of its market share in the telephone and cellular telephone industries via the sales of its futuristic clam-shell flip phones. Another example is the make of transparent chasses for personal computers, mice, and other consumer electronics that show the internal components of the electronics.

The present invention provides an electronic device switch that, in addition to controlling a certain function of the device, sets off the display of a light sequence or pattern that is aesthetically appealing. It is believed that the incorporation of such a switch in an electronic device would give the device a futuristic feel and boost its sales.

### SUMMARY OF THE INVENTION

The present invention is directed to a control feature that is suitable to be incorporated in any electronic device and, in addition to controlling various functions of the device, triggers the display of a light sequence or pattern when a particular function of the electronic device is activated or deactivated.

In a preferred embodiment, a control feature of an electronic device in accordance with the present invention includes a plurality of buttons, keys or switches, each of which controls a certain function of the electronic device, such as power on and off. In addition, the control feature includes a plurality of Light Emitting Diode (LED) lights, each of which is an indicator of whether a function has been activated or the degree at which a particular function has been set or programmed. Most importantly, the control feature includes a means for using the existing functional LED lights to create a light sequence or pattern which is displayed when a particular function is activated or deactivated.

### BRIEF DESCRIPTION OF THE DRAWINGS

The foregoing and other objects, aspects and advantages will be better understood from the following description of the embodiments in accordance with the present invention with reference to the accompanying drawing, wherein:

FIG. 1 is a top view of an exemplar control feature in accordance with the present invention.

### DETAILED DESCRIPTION OF THE INVENTION

The subject invention discloses a control feature for an electronic device that generates the display of a light sequence or pattern when a particular function of the device is activated or deactivated.

It is well known in the art that LED lights are often used with control buttons, keys or switches in electronic devices to indicate the activation of a particular function or the degree of such function. For example, a LED light that is on, adjacent to, or embedded in a power-on button emits visible light when the power is turned on (i.e., when the button is pushed), and turns off when the power is turned off. Another LED light next to a control key labeled “med” may be lit when the key is pressed to denote that the device is operating at medium speed or power. LED can be used to emit different colored lights, depending on the material used.

A control feature in accordance with the present invention uses the aforementioned LED lights, which are normally used to indicate the activation of a specific function or the state of that function, to display a light sequence or pattern when the same function is activated and/or deactivated.

In other words, when a control button, key or switch is pressed, turned or otherwise engaged to activate a specific function, a particular light sequence or pattern is displayed via the LED lights. It is preferred that only the LED lights that are also used as function indicators are employed to display the light sequence or pattern—no LED lights are used solely for displaying light sequences or patterns.

The technology for creating a light sequence or pattern using LED lights to be set off by the press of a button is well known. For example, the LEDs may be designed to have an electronic current run through them at different times or delayed intervals when a control key is pressed. Additional means for creating an LED light sequence or pattern are available and well known.

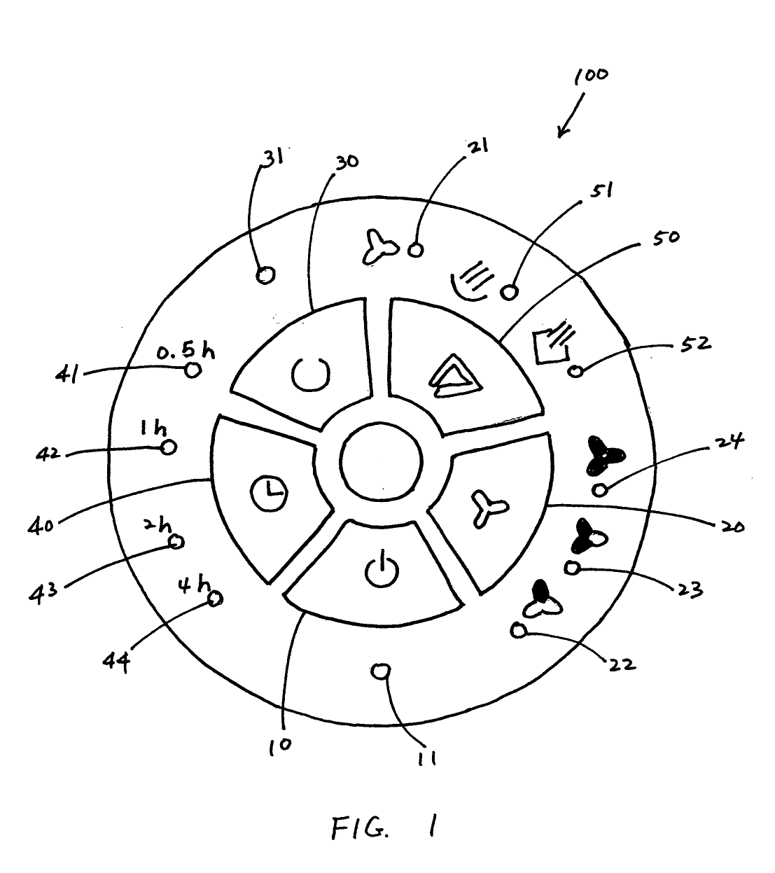

Turning now to FIG. 1, a control feature for an electric fan and in accordance with the present invention is illustrated. The control feature 100 includes a power on/off button 10 and corresponding power LED light 11; a fan speed button 20 and corresponding fan-on LED light 21, low speed LED light 22, medium speed LED light 23, and high speed LED light 24; an oscillation button 30 and corresponding oscillation LED light 31; a timer button 40 and corresponding 0.5 h LED light 41, 1 h LED light 42, 2 h LED light 43, and 4 h LED light 44; a pre-set program button 50 and corresponding pre-set sleep mode LED light 51 and pre-set day-time mode LED light 52.

As their names suggest, LED lights 11, 21, and 31 become lit when their corresponding control buttons 10, 20, and 30, respectively, are pressed to activate their corresponding functions. Likewise, the LED lights 11, 21, and 31 are turned off when their corresponding control buttons are pressed again to deactivate their respective functions.

LED lights 41, 42, 43 and 44 indicate the status of the timer function, which is controlled by timer button 40. For example, when the power is on, the timer button 40 may be pressed once to set an auto-off timer for 30 minutes, or 0.5 hour. Accordingly, the 0.5 h LED light 41 would turn on and remain on until the end of the 30-minute cycle, at which time the power shuts off and the 0.5 h LED light 41 turns off. Similarly, the timer button 40 may be pressed two times to set the time at 1 hour, or three times to set the time at 2 hours, etc.

The timer button 40 may also be used to program an automatic power on. When the power is off, the timer button 40 may be pressed twice, for example, to set an auto-on timer for one hour. The 1 h LED light would blink for 30 minutes and, at the end of the time cycle, turn off and the 0.5 h LED light would come on and blink for another 30 minutes. At the end of the second 30 minute cycle, the 0.5 h LED light turns off while the power turns on simultaneously.

LED lights 51 and 52 indicate the activation of one of two pre-set programs, which can be selected back and forth by pressing the pre-set program button 50 one or more times.

As described above, therefore, each of the LED lights is used to indicate the activation, status or degree of a particular function. However, all of these LED lights are also used to display a light sequence or pattern.

For example, when the electric fan is off and the power on/off button 10 is pressed, the following light sequence is displayed: the LED lights flash one after another, starting with the power LED light 11, clockwise and sequentially for three revolutions around the control buttons; followed by three simultaneous flashes of all of the LED lights. After the completion of the aforesaid light sequence, the power is turned on.

Furthermore, when the power is already on and the power on/off button 10 is pressed, the following light sequence is displayed: the LED lights flash one after another, starting with the power LED light 11, counterclockwise and sequentially for three revolutions around the control buttons; followed by two simultaneous flashes of all of the LED lights; followed by a simultaneous and gradual dimming and fading off of all of the LED lights. Subsequent to the display of the light sequence, the power is turned off.

Although the invention herein has been described with references to particular embodiments, it is to be understood that the embodiments are merely illustrative of, and are not intended as a limitation upon, the principles and application of the present invention. It is therefore to be understood that various modifications may be made to the above mentioned embodiments and that other arrangements may be devised without departing from the spirit and scope of the present invention.

For example, control buttons other than the power on/off button may be used to trigger a light sequence or patter, which sequence or pattern may be the same or different than the ones disclosed herewith.

In addition, although LED lights are preferred, other display technologies may be used to create a control feature in accordance with the present invention. For example a Liquid Crystal Display (LCD) may be used and the light sequence or pattern may be shown on the LCD screen. Alternatively, the control buttons may be backlit instead of having LED lights adjacent to them. Moreover, backlit icons embedded in the control buttons may be used. Other lighting devices such as incandescent lamps and any combination or permutation of any of the above or other technologies may also be used.

I claim:

1. A control feature for an electronic device, comprising a means for displaying a light sequence or pattern when a function of the electronic device is activated or deactivated.

2. The control feature of claim 1, wherein the means for displaying a light sequence or pattern displays a first light sequence or pattern when the function is activated, and a second light sequence or pattern when the function is deactivated.

3. The control feature of claim 2, wherein the first and second light sequences or patterns are identical.

4. The control feature of claim 2, wherein the first and second light sequences or patterns are different.

5. The control feature of claim 4, wherein the function is a member of the group consisting of instant power on and off, and automatic power on and off using a timer.

6. The control feature of claim 5, wherein the first and second light sequences or patterns are displayed by using a member of the group consisting of button backlit, icon backlit, LCD, and LED lights.

7. The control feature of claim 6, wherein the first and second light sequences or patterns are displayed with a plurality of LED lights each of which is also used to indicate the activation or deactivation of a particular function.

8. The control feature of claim 7, wherein the LED lights are positioned in a circular arrangement; wherein the first light sequence or pattern comprises three revolutions of a clockwise and sequential flash of each of the LED lights followed by three simultaneous flashes of all of the LED lights; and wherein the second light sequence or pattern comprises three revolutions of a counterclockwise and sequential flash of each of the LED lights followed by two simultaneous flashes of all of the LED lights followed by a simultaneous and gradual dimming and fading off of all of the LED lights.

9. An electronic device having the control feature of claim 1.

10. The electronic device of claim 8, wherein the light sequence or pattern is displayed with a plurality of LED lights each of which is also used to indicate the activation or deactivation of a particular function.

11. A method for creating a visual effect associated with at least one function of an electronic device, comprising:
creating a light sequence or pattern for the at least one function of an electronic device; and
displaying the light sequence or pattern when the at least one function is activated or deactivated.

12. The method of claim 11, wherein the activation and deactivation of the at least one function is controlled by a corresponding switch.

13. The method of claim 12, wherein a first light sequence or pattern is created and displayed when the at least one function is activated, and a second light sequence or pattern is created and displayed when the at least one function is deactivated.

14. The method of claim 13, wherein the first and second light sequences or patterns are identical.

15. The method of claim 13, wherein the first and second light sequences or patterns are different.

16. The method of claim 15, wherein the at least one function is selected from the group consisting of instant power on and off, and automatic power on and off using a timer.

17. The method of claim 16, wherein the first and second light sequences or patterns are displayed by using a member of the group consisting of switch button backlit, switch icon backlit, LCD, and LED lights.

18. The method of claim 17, wherein the first and second light sequences or patterns are displayed using a plurality of LED lights each of which is also used to indicate the activation or deactivation of a particular function.

19. The method of claim 18, further comprising positioning the plurality of LED lights in a circular arrangement, wherein the first light sequence or pattern comprises three revolutions of a clockwise and sequential flash of each of the LED lights followed by three simultaneous flashes of all of the LED lights; and wherein the second light sequence or pattern comprises three revolutions of a counterclockwise and sequential flash of each of the LED lights followed by two simultaneous flashes of all of the LED lights followed by a simultaneous and gradual dimming and fading off of all of the LED lights.
